(19) United States
(12) Patent Application Publication
(10) Pub. No.: US 2007/0078714 A1
(43) Pub. Date: Apr. 5, 2007

(54) Automatically matching advertisements to media files

(75) Inventors: Edward Stanley Ott IV, Palo Alto, CA (US); Nathanael Joe Hayashi, Piedmont, CA (US)

Correspondence Address: James J. DeCarlo;GREENBERG TRAURIG, LLP, MetLife Building, 200 Park Avenue, New York, NY, 10166, US

(73) Assignee: Yahoo! Inc., Sunnyvale, CA (US)

(21) Appl. No.: 11/347,626

(22) Filed: Feb. 2, 2006

Related U.S. Application Data
(60) Provisional application No. 60/722,600, filed on Sep. 30, 2005.

(51) Int. Cl. G06Q 30/00

(52) U.S. Cl. 705/14

(57) ABSTRACT

The present invention relates to a system and method for selecting advertisement for delivery over a network in response to requests received from remote computing devices. In one aspect, the present invention includes a method and system for automatically matching an advertisement with a media file, such as a podcast episode, when the media file has been requested by a consumer. Aspects of the present invention allow for automatic selection of advertisements after the creation of the media file, potentially without any interaction between the creator and the advertiser.

### RELATED APPLICATIONS

This application claims the benefit of U.S. Provisional Application No. 60/722,600, filed Sep. 30, 2005 which application is hereby incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The expansion of the Internet and the World Wide Web (“web”) has given computer users the enhanced ability to listen to and to watch various different forms of media through their computers. This media can be in the form of audio music, music videos, television programs, sporting events or any other form of audio or video media that a user wishes to watch or listen to.

Podcasting is a method of publishing digital media, typically audio programs, via the Internet, allowing users to subscribe to a feed of new files (e.g., MP3s audio files). The word “podcasting” became popular in late 2004, largely due to automatic downloading of audio onto portable players or personal computers. Podcasting is distinct from other types of online media delivery because of its subscription model, which uses a “feed,” which may also be referred to as a “podcast,” to describe, identify and deliver an media file. A feed, in this context, refers to a list of files that can be easily interpreted to identify new files in the list as the files are added over time. Thus, one is said to subscribe to a feed because as new files are added to the list, the subscriber is notified of the new file and, in some cases, the new file is automatically delivered. The feed may exist as a discrete file, such as an RSS file discussed below, or it may exist as part of a some other data format or element.

Podcasting enables independent producers to create self-published, syndicated media, such as “radio shows,” and gives broadcast news, radio, and television programs a new distribution method. Listeners may subscribe to feeds using “podcatching” software (a type of aggregator), which periodically checks for and downloads new content automatically. Most podcatching software enables the user to copy podcasts to portable music players. Most digital audio player or computer with audio-playing software can play podcasts. From the earliest RSS-enclosure tests, feeds have been used to deliver video files as well as audio. By 2005 some aggregators and mobile devices could receive and play video, but the “podcast” name remains most associated with audio. Other names are sometimes used for casting other forms of media, such as blogcasting for text and vcasting or vodcasting for video. For the purposes of this application, podcast is used in its most general sense to refer to a feed of new files in any format (e.g., .MP3, .MPEG, .WAV, .JPG) and containing any content (e.g., text-based, audible, visual or some combination) that can be subscribed to by a client. Also, for the purposes of this discussion an individual podcast may be referred to as a series, and each distinct new file in the series may be referred to as an individual episode of the series.

Podcasting is supported by underlying feed formats such as RSS. RSS is a family of XML file formats for web syndication used by (amongst other things) news websites and weblogs. The abbreviation is used to refer to the following standards: Rich Site Summary (RSS 0.91); RDF Site Summary (RSS 0.9 and 1.0); and Really Simple Syndication (RSS 2.0).

The technology behind RSS allows a client, in a client-server environment, to subscribe to RSS feeds on websites maintained by remote servers; these are typically sites that change or ad content regularly. To use this technology the client needs some type of aggregation service or aggregator. The aggregator allows a client to subscribe to the podcasts that the client wants to get updates (i.e. future media files in the feed) on. Unlike typical subscriptions to pulp-based newspapers and magazines, your RSS subscriptions are free, but they typically only provide a line or two of each article or post along with a link to the full article or post.

The RSS formats provide web content or summaries of web content together with links to the full versions of the content, and other meta-data. This information is delivered as an XML file called RSS feed, webfeed, RSS stream, or RSS channel. In addition to facilitating syndication, RSS allows a website's frequent readers to track updates on the site using an aggregator.

A program known as a feed reader or aggregator can check RSS-enabled webpages on behalf of a user and display any updated articles that it finds. It is now common to find RSS feeds on major web sites, as well as many smaller ones. Client-side readers and aggregators are typically constructed as standalone programs or extensions to existing programs like web browsers. Such programs are available for various operating systems.

Podcasting has become a very popular and accepted media delivery paradigm. This success has caused the number and variety of podcasts available to clients to grow exponentially. Potential podcast consumers are now confronted with the problems of how to find podcasts, how to organize and manage their podcast subscriptions; and how to listen to episodes efficiently and easily. Podcast publishers are also confronted with problems including how to effectively market their podcasts, how to generate income from their podcasts, how to easily create and disseminate podcasts, how to support different feed formats and device needs, and how to manage bandwidth and storage costs.

Due to its popularity, various business interests are interested in using podcasting as a medium for advertising. Currently, advertisements are used in conjunction with podcasts and other media files in one of two ways, either advertisements are provided separately (such via “pop-up” windows) to consumers downloading a podcast episode or the advertisements are incorporated into the podcast episode itself. Both methods limit the ability of advertisers to effectively display their advertisements using this new medium; pop-up ads may be blocked and easily ignored and pre-created episodes can not be tailored to different target groups, modified over time, or otherwise changed to meet the needs of the ongoing advertiser. Although, this is a problem for the advertiser, it also represents a loss in potential revenue for the podcast publisher as well.

### SUMMARY OF THE INVENTION

The present invention relates to a system and method for selecting advertisement for delivery over a network in response to requests received from remote computing devices. In one aspect, the present invention includes a method and system for automatically matching an advertisement with a media file, such as a podcast episode, when the media file has been requested by a consumer. Aspects of the present invention allow for automatic selection of advertisements after the creation of the media file, potentially without any interaction between the creator and the advertiser.

In one example (which example is intended to be illustrative and not restrictive), the present invention may be considered a system for selecting an advertisement from a set of advertisements. The system may include a request interception module adapted to receive a request for a media file and to inspect the request to determine if an advertisement is associated with the media file. An advertisement retrieval module is also provided to select an advertisement and retrieve the selected advertisement from an advertisement library based on information contained in the request. The system also may include a transmission module adapted to create a response to the request and to transmit the response, the response including the selected advertisement and when rendered resulting in the rendering of the advertisement.

In addition, the system may include an advertisement library containing a plurality of advertisements, the plurality of advertisements including the selected advertisement. The may also include a set of advertisement selection rules including at least one rule dictating the selection of the selected advertisement from a plurality of advertisements based on information contained in the request. The request interception module may also be adapted to receive a request from a rendering device and the transmission module is adapted to transmit the response to the rendering device. The system may include a media file library containing the media file and the media file library may be accessible at a first network location remote from the request interception module. Similarly the advertisement library may be accessible at a second network location remote from the advertisement insertion module. The system may be provided with a billing module that automatically generates a bill for an advertiser associated with the selected advertisement. The system may also be provided with a location module adapted to determine a physical location associated with the rendering device based on information in the request, in which case the advertisement retrieval-module may be further adapted to select an advertisement based on the physical location associated with the rendering device.

In one example (which example is intended to be illustrative and not restrictive), the present invention may be considered a method for selecting an advertisement from a set of advertisements. In the method, a request for a media file is received, such as from a rendering device. An advertisement is then selected from a plurality of advertisements based on the request and the selected advertisement is transmitted to the requesting device.

The selection may be made based on information previously associated with a user associated with the request. The selection may be made based on information previously associated with a media file associated with the request. The selection may also be based on a physical location associated with the request such as the physical location of the source-of the request or the physical location of the destination where responses to the request should be transmitted.

In another example (which example is intended to be illustrative and not restrictive), the present invention may be considered a computer-readable medium containing instructions for a computer-implemented method for automatically selecting an advertisement. The computer-readable medium contains instructions for performing a method that includes receiving a request, such as a request for-a media file from a rendering device. An advertisement is then selected from a plurality of advertisements based on the request and the selected advertisement is transmitted to the requesting device.

In another example (which example is intended to be illustrative and not restrictive), the present invention may be considered a method for targeting an advertisement to a member of a population based on tags associated with a requested media file. In the method a database of tags previously provided by members of the population is maintained. A request for a media file is received from the member of the population and the database is accessed for tags associated with the media file. A set of one or more first tags associated with the media file is obtained. Each first tag includes a description of the media file previously provided by at least one member of the population to describe the media file and a tag density associated with the description. An advertisement is then selected from a plurality of advertisements based on the descriptions and tag densities in the set of first tags. The selected advertisement is then transmitted to the member of the population.

In another example (which example is intended to be illustrative and not restrictive), the present invention may be considered a method for targeting an advertisement to a member of a population based on tags previously provided by the user to describe media files. In the method a database of tags previously provided by members of the population is maintained. A request for a media file is received from the member of the population and the database is accessed for tags associated with the member sending the request. A set of one or more first tags previously provided by the member is obtained. Each first tag includes a media file descriptor previously provided by the member and a tag density associated with the descriptor indicative of the number of times the member has described a media file with the descriptor. An advertisement is then selected from a plurality of advertisements based on the descriptors and tag densities in the set of first tags. The selected advertisement is then transmitted to the member of the population.

Additional features of the invention will be set forth in the description which follows, and in part will be apparent from the description, or may be learned by practice of the invention. The benefits and features of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 is a schematic illustrating an exemplary network architecture according to one embodiment of the present invention;

FIG. 2 is an illustration of an exemplified embodiment of an architecture for an advertisement selection system;

FIG. 3 is an exemplary user interface 300 capable of generating a request for a media file according to an embodiment of the present invention;

FIG. 4 is an exemplary user interface showing the results of a podcast search according to an embodiment of the present invention;

FIG. 5 is a flowchart depicting an embodiment of a method for providing an advertisement with a media file in accordance with the present invention;

FIG. 6 is a flowchart depicting in greater detail an embodiment of a method for retrieving an advertisement and providing it with a media file in accordance with the present invention;

FIG. 7 is a flowchart depicting in greater detail yet another embodiment of a method for retrieving an advertisement and providing it with a media file in accordance with the present invention;

FIG. 8 is a flowchart depicting in greater detail yet another embodiment of a method for retrieving an advertisement and streaming media data from the advertisement and the requested media file in accordance with the present invention;

FIG. 9 is a flowchart depicting in greater detail yet another embodiment of a method for selecting an advertisement in accordance with the present invention; and

FIG. 10 is a flowchart depicting in greater detail yet another embodiment of a method for selecting an advertisement in accordance with the present invention.

### DETAILED DESCRIPTION OF PREFERRED EMBODIMENTS

In general, the present invention relates to a system and method for delivering media files with advertisements over a network. As used herein, the terms “content”, “media”, or “media files” are used broadly to encompass any type or category of renderable, experienceable, retrievable, computer-readable filed and/or stored media, either singly or collectively, and individual items of media or content are generally referred to as entries, songs, tracks, pictures, images, items or files, however, the use of any one term is not to be considered limiting as the concepts features and functions described herein are generally intended to apply to any storable and/or retrievable item that may be experienced by a user, whether aurally, visually or otherwise, in any manner now known or to become known. Further, the term media includes all types of media such as audio and video.

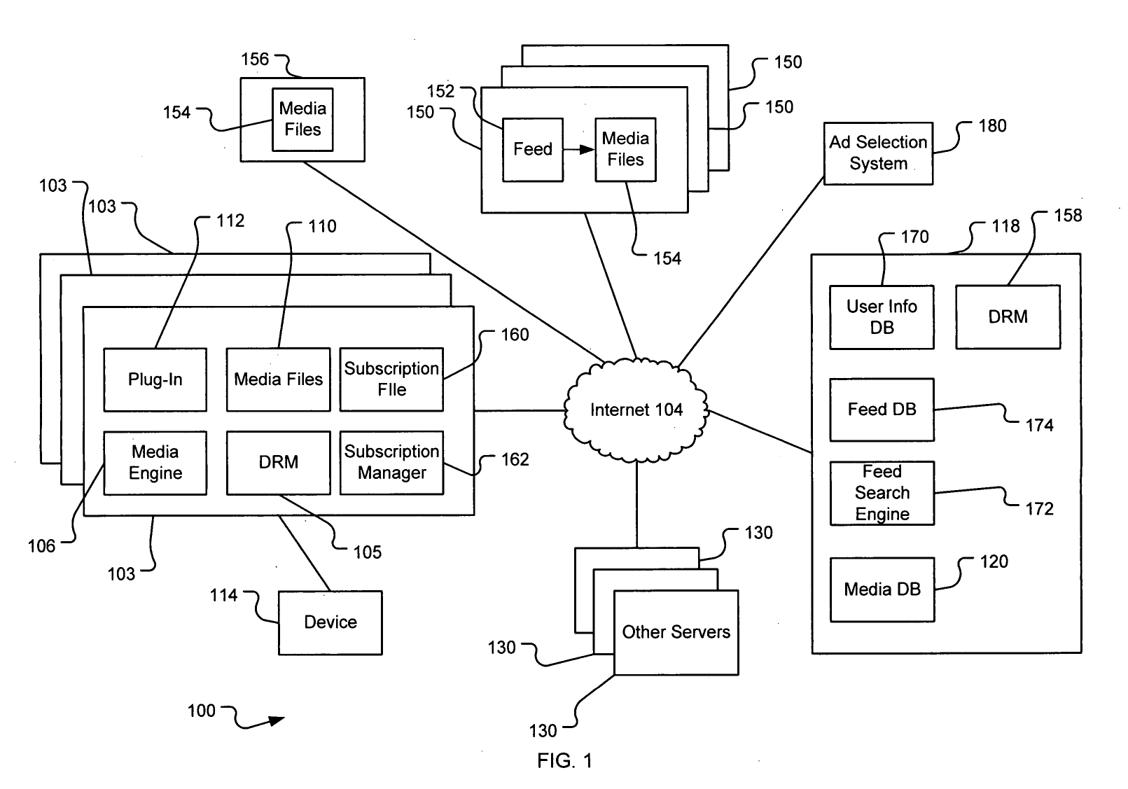

Embodiments of the present invention will now be discussed with reference to the aforementioned figures, wherein like reference numerals refer to like components. Referring now to FIG. 1, the architecture of one embodiment of the present invention is shown in schematic form. As can be seen in FIG. 1, a system 100 according to one embodiment of the present invention is shown. In general the system 100 allows users to experience, share and otherwise utilize different media. Although numerous exemplary embodiments will be discussed in terms of music and/or audio files, this invention can also be utilized with any form of audio, video, digital or analog media content, as well as any other media file type now known or to become known.

Each user utilizes a computing device 103 having a computing device, such as personal computer (PC), web enabled cellular telephone, personal digital assistant (PDA) or the like, coupled to the Internet 104 by any one of a number of known manners. Furthermore, each computing device 103 preferably includes an Internet browser (not shown), such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users. Each computing device also includes a media engine 106 that, among other functions to be further described, provides the ability to convert information or data into a perceptible form and manage media related information or data so that user may personalize their experience with various media.

A media engine 106 may be incorporated into computing device 103 by a vendor of computing device 103, or obtained as a separate component from a media engine provider or in some other art recognized manner. As will be further described below, it is contemplated that media engine 106 may be a software application, or a software/firmware combination, or a software/firmware/hardware combination, as a matter of design choice, that serves as a central media manager for a user and facilitates the management of all manner of media files and services that the user might wish to access either through a computer or a personal portable device or through network devices available at various locations via a network. As used herein, the term media file is used generically to refer to an item of media, as well as associated metadata and/or network location information for that item. A computing device 103 may also be referred to as a rendering device 103 to indicate that it is adapted to retrieve and render media files from the network.

Computing device 103 also may include storage of local media files 110 and/or other plug-in programs 112 that are run through or interact with the media engine 106. In one embodiment, media files 110 are audio files. In another embodiment, media files are video files. In yet another embodiment, media files can be a combination file compatible with a MPEG -21 standard or the like. Computing device 103 also may be connectable to one or more portable devices 114 such as a compact disc player and/or other external media file player, commonly referred to as an MP3 player, such as the type sold under the trade name ipod by Apple Computer, Inc., that is used to portably store and play media files.

Local files may be stored on a mass storage device (not shown) that is connected to the computing device 103 or alternatively may be considered part of the computing device 103. The mass storage device and its associated computer-readable media, provide non-volatile storage for the computing device 103. Although the description of computer-readable media contained herein refers to a mass storage device, such as a hard disk or CD-ROM drive, it should be appreciated by those skilled in the art that computer-readable media can be any available media that can be accessed by the computing device 103.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Additionally, computing device 103 may contain Digital Rights Management software (DRM) 105 that protects the copyrights and other intellectual property rights of the user's media files by enabling secure distribution and/or preventing or hampering illegal distribution of the media files. In one embodiment, DRM 105 encrypts or decrypts the media files for controlled access by authorized users, or alternatively for marking the content with a digital watermark or similar method so that the content can not be freely distributed. Media engine 106 preferably uses the DRM information to ensure that the media files being experienced through media engine 106 are not copied to or shared with users that are unauthorized to listen to or view the content.

The computing device 103 may include the software necessary to subscribe to podcasts. In the embodiment shown, the computing device 103 includes a subscription file 160, such as an OPML file. The subscription file 160 maintains information that identifies what podcasts the user has subscribed to. The subscription file 160 may include a list of feeds 152 and the feed locations.

The computing device 103 also includes a subscription manager 162. The subscription manager 162 can perform the podcatching functions of an aggregator and can periodically poll the feeds identified in the subscription file 160 to determine if new episodes of the podcast are available. Upon determination that a new episode is available, the subscription manager 162 may notify the user or may automatically download the episode to the computing device, such as by retrieving it from a location, such as a media server 150, via the network 104.

The system 100 also includes subscription server 118. In addition to serving media over the Internet 104 to the user, subscription server 118 includes a media database 120, which in addition to storing the actual media files also stores or communicates with storage devices storing various metadata attributes associated with particular pieces of media. Database 120 may be distributed over multiple servers provided with mass storage devices or other forms of computer-readable media or contained in a large mass storage device accessible the subscription server 118. Other servers 130 make other content and services available and may provide administrative services such as managing user logon, service access permission, digital rights management, and other services made available through a service provider. Although some of the embodiments of the invention are described in terms of music, embodiments can also encompass any form of streaming or non-streaming media including but not limited to news, entertainment, sports events, web page or perceptible audio, video or image content. It should be also be understood that although the present invention is described in terms of media content and specifically audio content, the scope of the present invention encompasses any content or media format heretofore or hereafter known.

The subscription server 118 also includes a database 170 of user information. The user information database 170 includes information about users that is collected from users or generated by the subscription server 118 as the user interacts with the subscription server 118. In one embodiment, the user information database 170 includes user information such as user name, gender, e-mail and other addresses, user preferences, etc. that the user may provide to the subscription server 118. In addition, the server 118 may collect information such as what podcasts the user has subscribed to, what searches the user has performed, how the user has rated various podcasts, etc. In effect, any information related to the user and the podcasts that user subscribes to that is available to the subscription server 118 may be stored in the user information database 170.

The user information database 170 may also include information about a user's devices 114. The information allows the subscription server 118 to identify the device and differentiate it from the computing device 103. Furthermore, it is anticipated that a single user may have multiple different computing devices 103 and each computing device 103 may be associated with different information. For example, a user may subscribe to a news podcast on a mobile device such as a smart phone 103 or similar Internet connected mobile device 103 and may subscribe to a gaming podcast on a home computer 103. The user information database 170 contains all this information. In one embodiment, the user information database 170 may include the same information contained in the computing device's subscription file 160 for each computing device 103 associated with the user. The user information database 170 may even include one or more files in the OPML file format for each user.

In the embodiment shown, the subscription server 118 includes a feed database 174. The feed database 174 may include a list of podcasts known to the server 118. This list may be periodically refreshed as the server 118 searches for new feeds 152 and for feeds 152 that have been removed from access to the internet 104. Such a feed database 174 may not be necessary if the searching ability of the server 118 is sufficient to quickly provide user with updated and accurate feed information in response to a user search. The feed database 174 may include all of the information provided by the feed 152. In addition, the feed database 174 may include other information generated by the subscription server 118 or by users. Thus, the feed database 174 may contain information not known to or generated by the publisher of the feed 152.

In one embodiment, the databases 120, 174, 170 may be separate and distinct databases, while in an alternative embodiment some or all of the databases 120, 174, 170 may be combined into a single database. The databases 120, 174, 170 part of the server 118 or may be located on separate computing devices that are in communication with the server 118.

In an embodiment, the feed database 174 includes additional information regarding feeds 152 in the form of “tags.” A tag is a keyword chosen by a person accessing the subscription server 1 18 to describe a particular feed 152. The tag can be any word or combination of key strokes. Each tag submitted to the subscription server may be recorded in the feed database 172 and associated with the feed the tag describes. Tags may be associated with a particular feed 152 (e.g., a series tag) or associated with a specific media file 154 within the feed 152 (e.g., an episode tag). Tags will be discussed in greater detail below.

Since tags can be any keyword, a typical name for a category, such as “science” or “business,” may also be used as a tag and in an embodiment the initial tags for a feed are automatically generated by taking the category designations from a feed and using them as the initial tags for the feed. However, note that tags are not a hierarchical category system that one “drills down” through. Tags are not hierarchically related as is required in the typical categorization scheme. Tags are also cumulative in that the number of users that identify a series or an episode with a specific tag are tracked. The relative importance of the specific tag as an accurate description of the associated content (i.e., series or episode) is based on the number of users that associated that tag with the content.

In an embodiment, consumers of feeds 152 are allowed to provide information to be associated with feeds or with particular episodes of feeds. Thus, the user after consuming data may rate an episode, say on a scale of 1-5 stars, write a review of the episode, and enter tags to be associated with the episode. All this consumer-generated data may be stored in the feed database 174 and associated with the appropriate episode for use in future searches.

The subscription server 118 includes a search engine 172. In an embodiment, the search engine 172 performs multiple functions including crawling the network 104 to identify feeds and episodes of feeds on the network 104, retrieving feed information and storing it in the feed database 174, and providing a means for computing devices 103 to easily search the feed database 174 for feeds and episodes.

Because of their very nature, feeds 152 are expected to change over time through the addition of new media files 154 as episodes of the feed 152. In an embodiment, the search engine 172 periodically and automatically crawls the network 104 to find new feeds 152 and for previously identified feeds 152 that have changed since the last time the search engine 172 inspected the feed 152. When crawling the network 104, the search engine 172 can use any network searching or crawling methods, such as for example, the method for crawling information on a network described in commonly owned U.S. Pat. No. 6,021,409, titled “METHOD FOR PARSING, INDEXING AND SEARCHING WORLD-WIDE-WEB PAGES.” The search engine 172 creates one or more new entries in the feed database 174 for every new feed 152 it finds. Initially, the entry or entries contain the location of the feed, an identifier of the feed (such as its name), and some or all of the information contained in or otherwise provided by or associated with the feed 152. For example, for an RSS feed this information may include some or all of the metadata within the RSS feed file. This feed information is retrieved by the search engine 172 from the feed 152 and stored in the feed database 174 so that the feed database contains some or all of the information provided in the feed 152. Such information may include the feed description, episode descriptions, episode locations, etc.

An automatic analysis may or may not be performed to match the feed 152 to known tags based on the information provided in the feed 152. For example, in an embodiment some RSS feeds include a category element and the categories listed in that element for the feed are automatically used as the initial tags for the feed. While this is not the intended use of the category element, it is used as an initial tag as a starting point for the generation of more accurate tags for the feed. Note that client searches on terms that appear in the feed 152 will return that feed as a result, so it is not necessary to provide tags to a new entry for a client search to work properly. Initially no ratings information or user reviews are associated with the new entry. The manager of the subscription server may solicit additional information from the publisher such as the publisher's recommended tags and any additional descriptive information that the publisher wishes to provide but did not provide in the feed 152 itself.

The feed database 174 may also include such information as reviews of the quality of the feeds, including reviews of the series as a whole and reviews specific to each episode in a given feed 152. The review may be a rating such as a “star” rating and may include additional descriptions provided by users.

In addition to maintaining information specific to series and individual episodes within the series, the feed database 174 may also include information associated with publishers of the feeds, sponsors of the feeds and/or episodes, topics discussed in the feeds or episodes or people in the feeds or episodes.

The feed database 174 may also include information concerning advertisers and advertisements associated with feeds and episodes. For example, associated with each feed may be a set of one or more advertisers or advertisements. This information may then be used to select an advertisement to be transmitted or streamed to a consumer's computing device 103 as will be described in greater detail below.

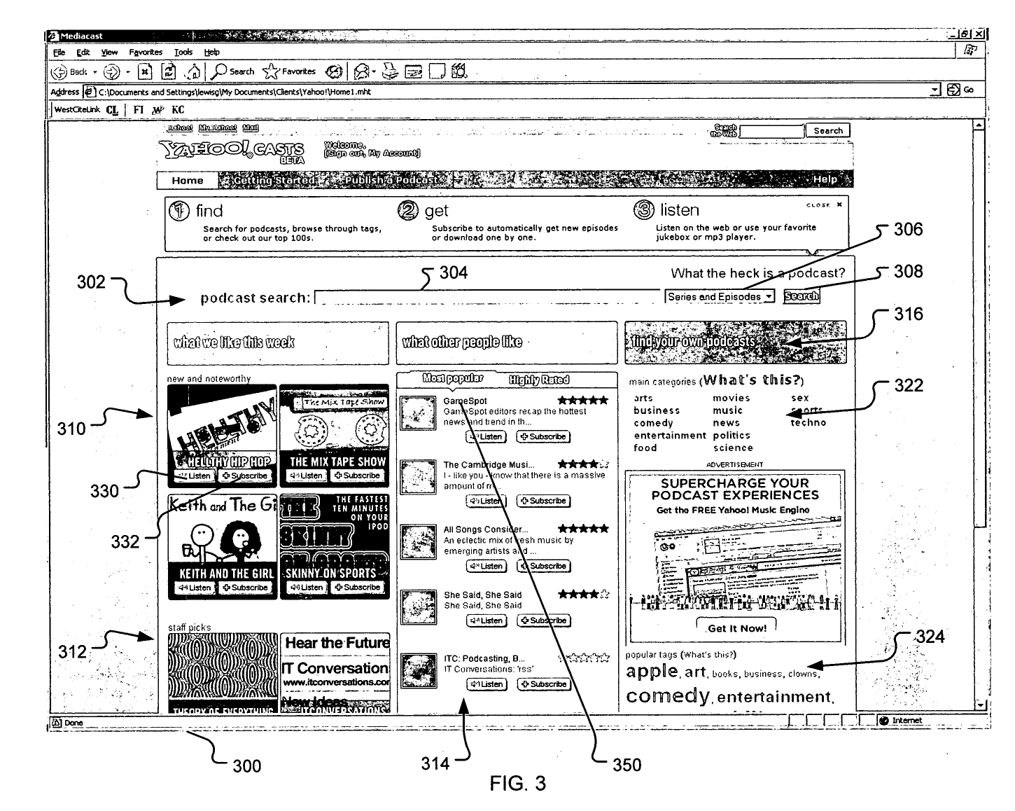

In order to facilitate client searches for podcasts, the feed search engine 172 provides a graphical user interface to user's computing devices 103 allowing the user to search for and subscribe to feeds 152 using the subscription server 118. In one embodiment, the graphical user interface may be an .HTML page served to a computing device 103 for display to the user via a browser. Alternatively the graphical user interface may be presented to the user through some other software on the computing device 103. An example of a graphical user interface presented to a user by a browser is discussed with reference to FIG. 3. Through the graphical user interface, the feed search engine 172 receives user search criteria. The search engine 172 then uses the search criteria as parameters to identify feeds 152 that meet the user's criteria. The search may include an active search of Internet 104, a search of the feed database 174, or some combination of both 174. The search may include a search of the descriptions provided in the feed 152 of the series and each particular episode in the series. The search may also include a search of the third party-provided tags, ratings, and reviews and other information associated with feeds 152 listed in the feed database 174 but not provided by the feeds 152 themselves. The results of the search are then displayed to the user.

In one embodiment of the present invention, similar to the DRM software 105 located on the user's computing device 103, the subscription server may maintain its own DRM software 158 which tracks the digital rights of media files located either in the media database 120 or stored on a user's computing device. Thus, for example, before the subscription server 118 streams or serves up or transfers any media files to a user, it validates the rights designation of that particular piece of media and only serves streams or transfers the file if the user has the appropriate rights. This may be determined by an inspection of information contained on the computing device 103, in the user information database 170, or both.

The system 100 also includes a number of media servers 150, that are remote from the computing devices 103 and the subscription server 118, that publish podcasts. In one embodiment remote means remote in the logical, network sense in that each media server 150, each computing device 103 and the subscription server 118 may be accessed using different domain names as their network locator, such as the Uniform Resource Locator (URL). For example, the subscription server 118 may be accessed by a URL of “http://podcast.yahoo.com” while each media server 150 may have a different URL such as “www.abcnews.com” and “www.itunes.com”. The computing devices 103 may have dedicated URLs or may be devices that can intermittently connect to the Internet 104 and are given temporary URLs by the system through which they connect. In another embodiment, Internet Protocol (IP) addresses for each computing device 103, media server 150 and the subscription server 118 are different, indicating that the devices are remote from each other, at least in a logical sense.

The servers 150 include one or more feeds 152, such as RSS feeds, that are accessible through the network 104, such as the Internet as shown. The feeds 152, as will be described in greater detail below, include information about the feed (series information) as well as information about the various media files 154 (i.e., episodes) of the feed 152. The feed 152 also identifies the media files 154 so that they can be retrieved by a subscription manager on a computing device 103. The media file 154 may reside on the media server 150 with the feed 152, or may be located on yet another server 156 that is, in fact, remote from the podcast server 150 with the feed 152.

As illustrated in FIG. 1, each user's computing device 103, the subscription server 118 and media servers 150, as well as the other servers 130, 156 are communicatively connected via the Internet 104. In alternate embodiments, different components of the system may be communicatively coupled differently, for example each may be coupled directly to each other wirelessly or by a local or wide area network (WAN) or the like. Additionally, functional components can be distributed so that certain functions of the search engine 172 may be performed at subscription server 118, or distributed in modular fashion for operation at various locations throughout the system 100. Thus, the description herein of a function or component being associated with a particular device or component or location is merely one possible embodiment.

The search engine 172 also provides users with additional functionality and convenience. The user interface provided by the search engine 172 to the user's computing device 103 allows the user to subscribe to a displayed feed (via a subscribe button), listen to an episode of a displayed feed (via listen button), and obtain the complete information on the feed (via clicking on the hyperlinked title) from the same interface. A user need not know where the feed resides on the Internet and need only to interact with the search engine's user interface to perform these actions. Furthermore, the user does not need to explicitly direct his computer to access the publisher's site to subscribe, listen or obtain additional information on a feed.

The system 100 also includes an advertisement selection system 180. The advertisement selection system 180 selects advertisements for transmission to consumers based on media file requests received from consumers. In the embodiment shown, the advertisement selection system 180 receives requests for media files 154; determines if an advertisement should be provided with the media file 154; prepares a response to the request; and transmits the response to the requesting device 103, 150, 118 or some other designated receiving device 103, 150, 118. In an embodiment, the response includes only the advertisement selected by the advertisement selection system 180, the media file be provided separately and independently to the requesting device 103, 150, 118 or some other designated receiving device 103, 150, 118 by another computing device other than the advertisement selection system 180. In an alternative embodiment, the response includes both an advertisement and the media file requested.

In an embodiment, the advertisement selection system 180 may be implemented as a separate, remote system that can be accessed by any server or computing device connected to the network 104. In an alternative embodiment, the advertisement selection system 180 may be implemented as part of a media server 150 or a subscription server 118. In yet another embodiment, various components of the advertisement selection system 180 may be separated and distributed among the media servers 150, subscription server 118 and computing devices 103 in a way the functions of the advertisement selection system 180 are performed even though no discernable single location on the network can be identified as the advertisement selection system 180.

The advertisement selection system 180 selects and provides advertisements for use with media files. The advertisement selection system 180 may directly or indirectly interact with the various servers and computing devices shown in FIG. 1, depending on the implementation. For example, in an embodiment, the advertisement selection system 180 may be adapted to interact only with media servers 150 as part of the media servers' 150 handling of requests for media files 154 and, thus, never directly interacting with consumers' computing devices 103. In an alternative embodiment, consumer requests for a media file 154 may be directed initially to the advertisement selection system 180, with or without the consumers' knowledge, such that the consumers' computing devices 103 never directly interact with a media server 150 that uses the advertisement selection system 180 to provide advertisements.

In an embodiment, in addition to selecting and retrieving an advertisement the advertisement selection system 180 may insert selected advertisements into media files or streams of media data. When inserting advertisements, the advertisement selection system 180 is designed to work with media files that were created with information identifying where in the media data of the media file an advertisement should be inserted and also with media files created without concern for inserting advertisements at a later time. The advertisement selection system 180 further tracks the advertisements inserted into or provided with media files. From this information, the advertisement selection system 180 is then able to bill advertisers and to credit media file publishers.

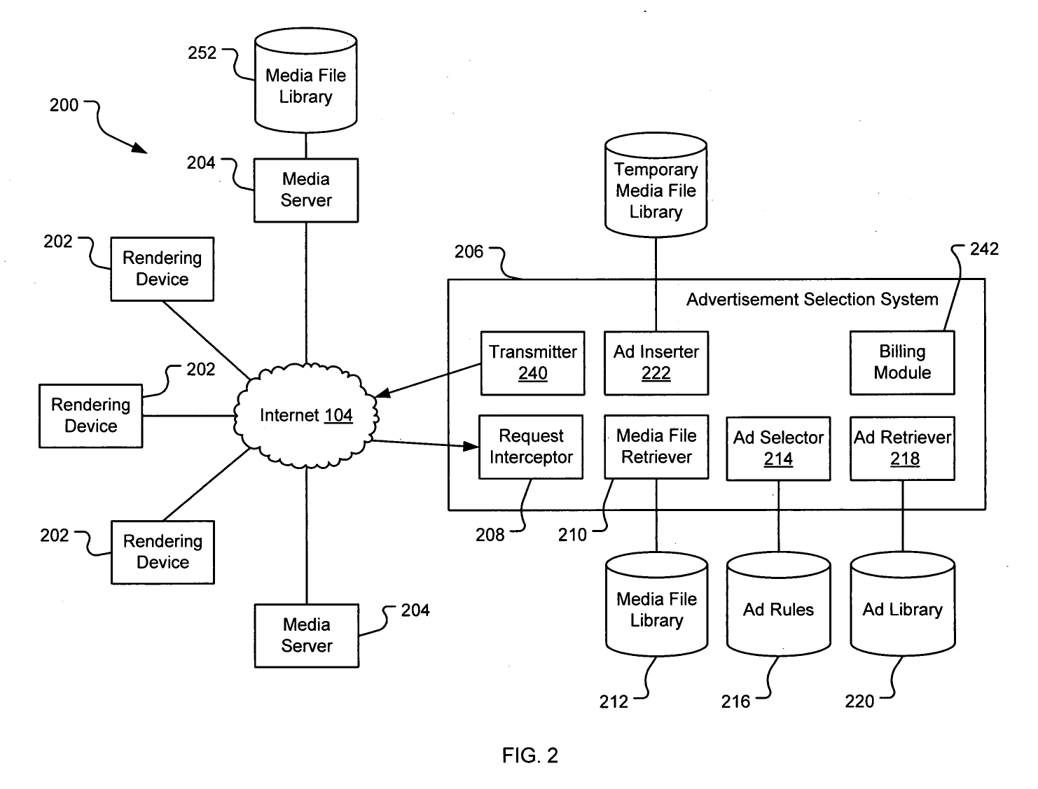

FIG. 2 is an illustration of an exemplified embodiment of an architecture for an advertisement selection system. In the architecture 200, consumers' computing devices, in the form of rendering devices 202, and media servers 204 communicate with the advertisement selection system 206 via a network such as the Internet 104. In the embodiment shown, the advertisement selection system 206 receives requests for media files; may make a determination of whether an advertisement should be provided with the media file; prepares a response to the request, including the selected advertisement; and transmits the response to the requesting device or some other designated receiving device. The response, when rendered, results in the advertisement being rendered to the consumer.

The example embodiment shown in FIG. 2 illustrates the functions of the advertisement selection system 206 as separate modules. Although not required, the invention is described for convenience in the general context of functional program modules, which may or may not correspond to specific computer-executable instructions that may be executed by a computer, such as a client workstation or a server. Generally, program modules include routines, programs, objects, components, data structures and the like that perform particular tasks or implement particular abstract data types. Although discussed as separate and distinct modules, one skilled in the art will realize that depending on the implementation choices made during development, some or all of the various modules may combined or further divided into independent sub-modules without changing the overall functionality of the embodiment. In additional, as discussed above in alternative embodiments some or all of the modules described may be distributed throughout other computing devices on the network 104.

The advertisement selection system 206 is provided with a request interceptor 208 for receiving requests from remote computing devices such as rendering devices 202 and media servers 204. In an embodiment, the requests are requests for media files that are handled by the advertisement selection system 206. The request interceptor 208 may receive requests directly from the rendering device, i.e., the requests are addressed to the advertisement selection system 206, or indirectly from other computing devices, i.e., the request is forwarded to the advertisement selection system with or without the rendering device's knowledge. In an alternative embodiment, additional request interceptor module may be implemented on a remote system 204 in order to intercept and forward requests for specified media files to the advertisement selection system 206.

The request interceptor 208 receives requests and selects an advertisement to be inserted into a response to the request. In an embodiment, the request interceptor 208 inspects the request and, based on the information in the request such as the requestor's identity, the source of the request, the time of the request and the media file being requested, the request interceptor 208 makes its selection. For example, the request interceptor 208 may maintain, as a type of advertisement selection rule, a list of media files for which advertisements should be provided. In an embodiment, the list may or may not also indicate what advertisement or advertisements should be provided in response to requests for each media file in the list. The request interceptor 208 may also access and retrieve additional information, such as maintained in a user database 170 or a feed database 174, as part of the determination process. In an alternative embodiment, the request interceptor 208 may not make any determinations and may treat all requests the same.

The advertisement selection system 206 in the embodiment shown also includes a media file retriever 210. The media file retriever 210 retrieves media files identified in the request. In an embodiment, the media file retriever 210 may retrieve files from a media file library 212 maintained by or otherwise accessible to the advertisement selection system 206. In an alternative embodiment, the media file retriever 210 may request and retrieve files from a remote media file library 252 maintained by a media server 204. In yet another embodiment, if the request was originally provided by a media server 204, the media file may have been provided with the request, in which case the media file retriever 210 may simply access the media file with the request. In yet another embodiment, the advertisement selection system 206 does not include a media file retriever 210 and is only capable of providing advertisements in response to media file requests.

The advertisement selection system 206 includes an advertisement selector module 214. The advertisement selector 214 selects the advertisement or advertisements that are to be provided with the responsive media file. In an embodiment, the advertisement selector 214 accesses a set of ad rules 216 as part of the selection process. The selection may be based on many different factors including the contents of the received request and may involve the accessing and retrieval of additional information, such as maintained in a user database 170 or a feed database 174. For example, advertisements (or “ads” for convenience) may be selected on geographical location of the requester, such information being obtainable by comparing a request's header information, such as an IP address assigned to the requestor's rendering device, with a DNS server directory. Ads may be selected based on such things as the requestor's demographic information or tag history of the user making the request, such information being obtainable from a user database 170. Ads may further be selected based on the capabilities of the rendering device that the media file will be rendered by. The reader will understand that any basis and information available may be used as part of the selection process to select a particular ad.

In yet another embodiment, ad rules 216 may include rules that an advertisement be provided only with a media file associated with one or more tags, such rules using information from a feed database 174 or some-other database such as a tag database containing tags or other information associated with known media files. Rules of this kind allow ads to be rendered based on consumer-supplied tags that are associated with the media file. In this way, although the advertisement is automatically selected by the advertisement selection system, the actual selections may vary over time as the tag information associated with a media file changes over time in response to receipt of additional consumer-supplied tags. Thus, consumer-supplied tags are yet another basis upon which an advertisement may be selected.

In a podcast specific embodiment, ad rules 216 may include rules based on what series a media file is associated with, e.g., the media file is an episode of a specific feed. Thus, advertisements may be automatically inserted based on the podcast allowing an advertiser to place advertisements in each episode of an entire podcast for a period of time.

After the ad is selected, an advertisement retriever 218 is provided to retrieve the selected ad. In the embodiment shown, the advertisement selection system 206 is in communication with an advertisement library 220. The advertisement library 220 may be a local mass storage device containing the advertisements selectable by the advertisement selection system 206. Alternatively, based on the ad or ads selected, the advertisement selection system 206 may access one or more remote advertisement libraries 220 maintained by advertisers or advertisers' representatives. The ad retrieved may itself be in the form of a media file or may be media data in a form renderable by the destination device or, alternatively, in a form ready for insertion into a file or a response.

The advertisement selection system 206 may or may not -include an advertisement inserter 222 that combines the media file and the advertisement. The combination may include adding some media data from the advertisement to the media file, creating a container for the advertisement and media file, or creating a new media file that is some combination of media data from the media file and the advertisement.

In an embodiment, a container, which may itself be a renderable media file containing the ad and the media file, is created by the advertisement inserter 222. The advertisement inserter 222 inserts the advertisement, or media data therefrom, and some or all of the data from the media file into the container. The advertisement may be inserted so that it is rendered before the media file is rendered, after the media file has been completely rendered, or at some point within the media file such that the media file is interrupted by the advertisement.

In another embodiment, the advertisement inserter 222 may create a response message that includes the advertisement, the media file and some directive to the ultimate rendering device to render the advertisement at a certain point relative to rendering the media data of the media file.

In a streaming embodiment, the advertisement inserter 222 may be responsible for creating the stream of media data and thus dictate at what point in the stream the media data from the advertisement should occur relative to the media data from the media file.

In yet another embodiment, the rendering device may already have the media file and the advertisement inserter 222 may then create a response that consists only of a selected advertisement and/or a directive to a rendering device. The directive may be a command identifying a location to insert the selected advertisement. Alternatively, the directive may be a link to an advertisement selected by the advertisement selector 214. Such an embodiment may be used when a rendering device already has the media file and the media file includes information identifying where an advertisement is to be rendered, in which case the rendering device only needs to obtain an advertisement.

The advertisement selection system 206 is provided with a transmit module 240 that packages the response, be it a data stream or a discrete file containing the selected advertisement or advertisements, for transmission to the appropriate destination. For example, the response may be packaged into an transport structure compliant with a communication protocol, such as HTTP, the SMTP, TCP/IP or PPP.

The advertisement selection system 206 further includes a tracking and billing module 242. The tracking and, billing module 242 maintains records of what ads were provided to whom and in response to what media file requests. In addition, more, less or different information may be recorded, such as the requestor's demographic, the requestor's e-mail address or other identifying information like a user identifier in a user database, and the source of the media file. The tracking and billing module 242 may automatically generate an electronic or paper invoice to advertisers based on the current contract between the advertiser and the operators of the advertisement selection system. The tracking and billing module 242 may automatically generate an electronic or paper payment, reward or credit to the publishers or owners of the media files with which the advertisements are provided. Such payments or credits may also be determined based on a current contract between the publisher and the operators of the advertisement selection system.

Note that embodiments of the system described above allow advertisements to be provided in response to requests for media files in real time without a direct prior interaction between the media file publisher and the advertiser that created and supplied the advertisement. In an embodiment, an advertiser may interact with the advertisement selection system to identify contract terms, ad rules and provided access to the advertiser's advertisements. The advertiser's advertisements are then automatically provided in accordance with the contract terms and ad rules with future media file downloads and render requests that are handled through the advertisement selection system.

Likewise, the publisher need only interact with the advertisement selection system as necessary to provide access to the media files conforming the requirements of the advertisement selection system. This may include routing media file requests to the advertisement selection system or installing some or all of the advertisement selection system's software on the publisher's media servers. This may also include the insertion of advertisement markers in the media files as described below. However, after the publisher has met the requirements, advertisements are then automatically provided by the advertisement insertion engine and the publisher need never negotiate with any advertisers directly.

FIG. 3 is an exemplary user interface 300 capable of generating a request for a media file according to an embodiment of the present invention. In the embodiment shown, the graphical user interface 300 is a podcast search engine capable of searching for podcasts and media files that are episodes of podcasts. One skilled in the are will understand that this is but one example of a graphical user interface, whether server generated or generated by a rendering device, from which a user may find and request a media file to be rendered.

The graphical user interface 300 (GUI) includes several areas within the interface, each containing one or more user interface elements. The GUI 300 includes several areas, each containing one or more displayed user interface elements. Examples of user interface elements include non-interactive elements such as text, images and video frames displayed to the user as well as interactive elements such as user controls, for example text boxes, links, scrollbars, icons, and dropdown boxes. In one embodiment, the GUI 300 is the “home” page of the feed search engine 172 that is displayed to computing devices 103 when the search engine 172 is accessed via a browser on the computing device 103.

The GUI 300 includes a podcast search area 302 within which the user can enter search criteria for podcasts. The search is initiated by a user command delivered via the “search” button 308. Via the drop down box 306 associated with the search field 304 a search can be limited to searching for only series, searching for only episodes or searching for both series and episodes that match the criteria.

The GUI 300 also includes an area 310 titled “New and Noteworthy,” a “staff picks” area 312, and a podcast recommendations area 314, as well as other areas for finding podcasts using tags. Within these areas, various podcasts are listed (such as for example the “GameSpot” podcast 350) or displayed. Associated with each podcast is displayed a “listen” button 330 and a “subscribe” button 332. The subscribe button 332 causes the computing device 103 to subscribe to the podcast associated with the button 332.

The listen button 330 causes the most recent episode of the identified series to be downloaded to the user's computing device 103 and rendered (e.g., displayed if text, or played with the appropriate media player if audio or video content) to the user by the computing device's media player. In an embodiment, user activation of the listen button 330 results in the execution of a server-based media player that streams the appropriate media file the user's browser for rendering in a specialized podcast user interface.

In an embodiment, user selection of the listen button 330 initiates an advertisement selection system. In one embodiment, a user selection of the listen button 330 causes the user's computing device to transmit a request for the associated media file of the episode. The request generated by the listen button 330 may include additional information derived from the GUI 300 or the user's computing device 103 that is usable by the advertisement selection system for selecting and providing an advertisement with the response containing the media file. For example, the request may include information identifying the user to the advertisement selection system or the subscription server, information identifying the capabilities of the user's computing device, and information regarding advertisements already received by the computing device.

The request, as determined by the listen button 330, may be transmitted to the advertisement selection system directly, or indirectly via transmission to the subscription server or a media server first where the request is intercepted and passed to the advertisement selection system.

Note that the GUI 300 allows the user to subscribe to a displayed feed (via a subscribe button), listen to an episode of a displayed feed (via listen button), and obtain the complete information on the feed (via clicking on the hyperlinked title) from the same interface 300. A user need not know where a feed or media file resides on the Internet. Furthermore, the user does not need to access the publisher's site to subscribe, listen to a media file, or obtain additional information on a feed.

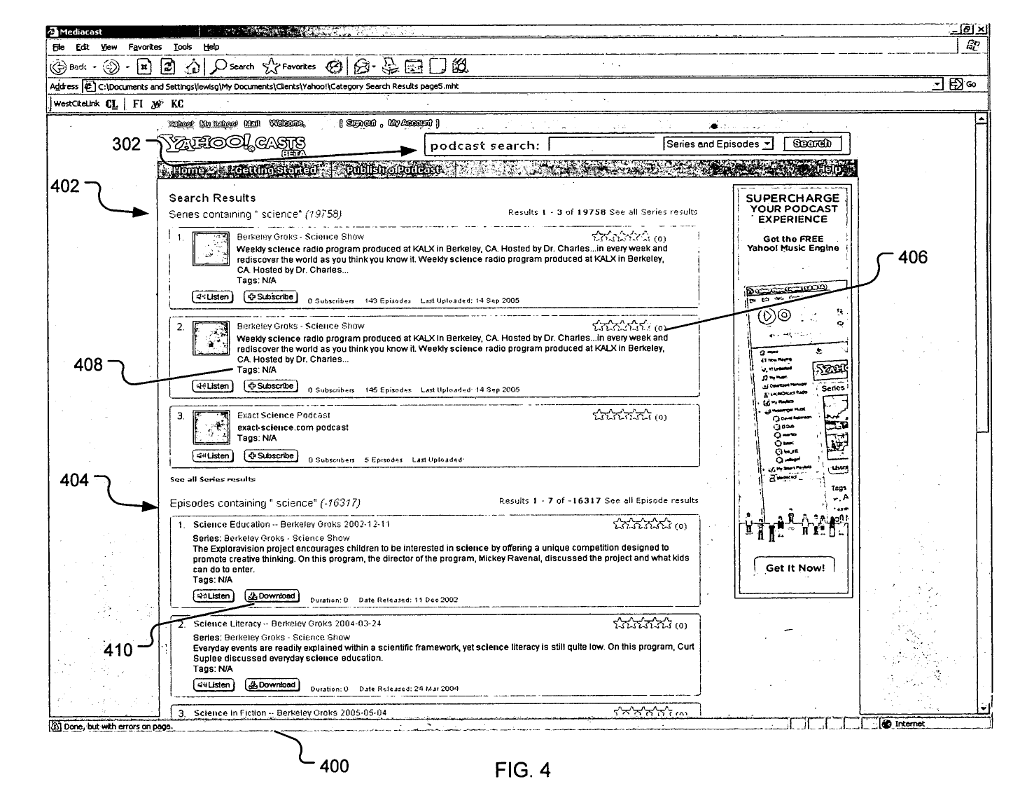

FIG. 4 is an exemplary user interface 400 showing the results of a podcast search according to an embodiment of the present invention. In the search results GUI 400 is divided into several areas including a search area 302 at the top of the GUI 400.

One area 402 shows the series that were returned as matching the search term “science.” In the GUI 400, the term “science” is shown in bold face to assist the user in identifying where the term was found.

The series results area 402 provides for each series listed the series title, description and image from the feed. In addition, a rating for each series as previously described is provided from the feed database. In addition to the rating “stars”, the rating also include a number of users display 406 that have rated the podcast to give the user additional information about the potential quality of the podcast. Listen and subscribe buttons are also provided allowing the user to listen to or subscribe to any listed series with a single command. An additional element in the listing 402 is a tag display 408 listing the tags that users have associated with the series. The tags are obtained from the feed database 174.

A user interface element is provided on the GUI 400 allowing the user to “view all series results.” Likewise another user interface element is provided on the GUI 400 allowing the user to “view all episode results.”

The episode results area 404 includes substantially the corresponding information for episodes as shown in the series results area 402. The episode results area 402 provides for each episode listed the episode title, the series title, and the episode description. In addition, a rating for each episode as previously described is provided from the feed database. In the embodiment shown, none of the episodes have been rated so no stars are filled in. In addition to the rating “stars”, the rating also include a number of users display 406 indicating the number of users that have rated the episode to give additional information about the potential quality of the episode's or feed's rating. Listen buttons and download buttons 410 are also provided allowing the user to listen to or download to any listed episode with a single command. An additional element in the listing 402 is a tag display 408 listing the tags that users have associated with the individual episode. The tags are obtained from the feed database 174 information associated with the episode.

In the embodiment, series titles and episode titles are user interface elements in the form of links that, when selected by a user such as via a mouse click on the link, open a series description page or an episode description page. These description pages include additional and more detailed information regarding the associated feed or episode.

In an embodiment, user selection of the listen button initiates an advertisement selection system as described above. In addition, user selection of the download button may also initiate advertisement selection system, causing the advertisement selection system to provide the associated media file and advertisement to be transmitted to the user's computing device.

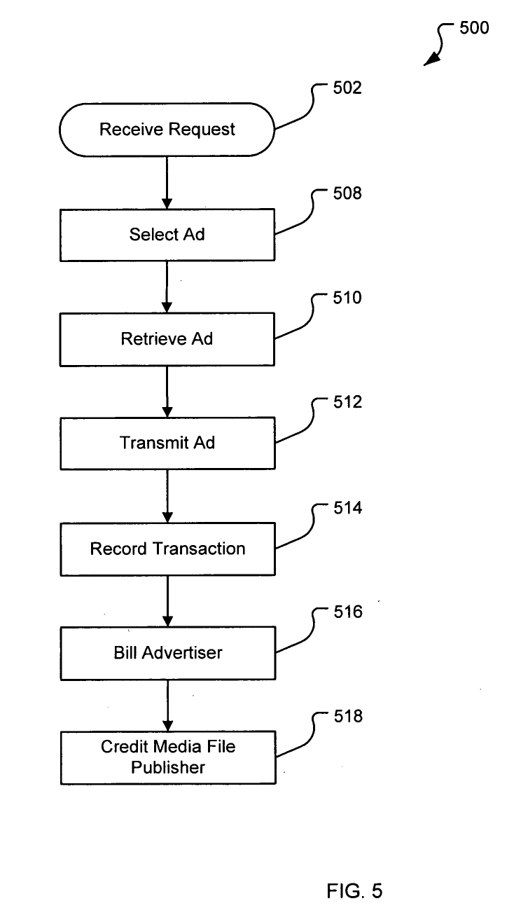

FIG. 5 is a flowchart depicting an embodiment of a method for selecting an advertisement in response to a request. In the embodiment 500, the method starts when a request is received in a receive request operation 502. The request may have been directed at the receiving computing device or may have been intercepted and rerouted from another location to the advertisement selection system. The request may or may not be received from the same computing device that the response is ultimately transmitted to in transmission operation 512.

For the purposes of the specification, in the embodiment 500 shown the request will be discussed as a request for a media file to delivered to a requesting rendering device. However, it should be understood that the request could potentially be a request for any type of file, or even a request for an action to be performed by the receiving computing device. Thus, any communication from a computing device to another could result in the remaining operations of the method 500 being performed.

The request is inspected and, if it is a request for which an advertisement should be provided, a selection operation 508 selects an advertisement that should be provided in response to the request. The selection may include inspecting the request, obtaining additional information from remote and local databases, and comparing any relevant information to a set of rules for what ad to select and how to provide or transmit the ad. The selection may be based on many different factors including the contents of the received request and may involve the accessing and retrieval of additional information, such as a user database 170 or a feed database 174. The selection operation 508 may include selecting one or more advertisements from a group of advertisements.

The selection operation 508 may include use of a logic decision tree, made up of rules for selection. For example, in an embodiment an advertiser may provide a set of ads for the same product or service, in which each ad is tailored to a different demographic, a different computing device capability (i.e., each ad is renderable by a different computing device), a different geographic location, or a different feed. Ad rules may then be created so that an ad tailored to football fans is transmitted to users interested in football or in response to requests for media files related to football, while an ad tailored to people in Los Angeles is transmitted to users in Los Angeles.

The ad rules may define a criteria that must be met for a specific ad to be transmitted. The criteria may be that a specific tag is associated with a requestor or a requested file. Additional examples of criteria are that the requester or the requested file: be associated with a specific geographic location, be associated with a specific demographic, be associated with a specific tag, or be associated with a tag or tags associated with some other designated media file.

In an embodiment, any information available to the advertisement selection system that can be associated with a request can be used in an ad rule as a criteria. For example, the number of times an ad has been delivered may be used as a criteria, allowing an advertiser to purchase a specific number of ad placements. The number of times an ad has been delivered criteria may be defined as a total number as is stored by the advertisement selection system, as the number of times the ad is delivered in response to requests for media files in a specific feed as may be stored in the feed database 174, or as the number of times the ad is delivered to a specific user as may be stored in the user database 170.

As another example, an ad tailored to football fans may have a criteria that the requestor or the media file must be associated with the tag “fantasy football” for the ad to be selected. The ad rules may be hierarchical so that the football ad rule is inspected first and, if the football ad rule criteria is not met (e.g., the requestor or media file is not associated with the tag “fantasy football”), a second ad rule is inspected next, and so on until an ad is selected. The hierarchy may end in the selection of a default ad or in the selection of no ad. The hierarchy may be determined in part based on how much an advertiser is willing to spend. Ad rules from one or more advertisers may be combined to form a set of ad rules for selecting advertisements from multiple advertisers.

After the ad is selected, a retrieve ad operation 510 retrieves the selected ad. The ad may be retrieved from a local or remote location, such as an advertisement library 220. The ad retrieved may itself be in the form of a media file or may be media data in a form ready for insertion into a file.

Next, the selected advertisement or advertisements are transmitted to the receiving device as directed by the request. In the embodiment 500 shown, the advertisement is packaged into a response and sent as directed by the request. As discussed above and in greater detail below, in an embodiment the transmission may include a media file as well as the selected ad, in which the ad may be transmitted as a separate media file. In another embodiment, the transmission may include a single file containing combined media data taken from the media file and the ad. In yet another embodiment, the transmission may be a stream of media data containing media data taken from the ad.

The method 500 also includes a record transaction operation 514 in which the particulars of the request and response are recorded. The record transaction operation 516 creates a record of what ads were provided with what media files and to whom. In addition, other information may also be recorded such as the requestor's demographic, the requestor's e-mail address or other identifying information, and the source of the media file.

The record transaction operation 514 also may include recording information in the user database 170 that the ad was transmitted to the user that initially authored the request. This information may be of use in the later generation of ads, for example so that the user does not receive the same ad multiple times or automatically receives a set of ads in a specified order.

The record transaction operation 514 also may include recording information in the feed database 174 that the ad was transmitted to consumers of the feed. This information may be of use by publishers in determining what feeds are popular with what advertisers. The information may also be of use to advertisers so that they can identify the results of their ad rules. Furthermore, this information may be of use in the later generation of ads, for example so that feeds with a recent history of providing ads from a specific advertiser are known. Advertisers can then create ad selection rules that automatically use this information, for example, to avoid providing competitive ads or to provide ads in the same feed that directly compete with certain advertisers.

A bill advertiser operation 516 is performed in which the advertiser is billed for the delivery of the advertisement to the consumer. The bill advertiser operation 516 may periodically and automatically generate an electronic or paper invoice to advertisers based on the current contract between the advertiser and the operators of the advertisement selection system.

The fee charged for a particular advertisement (and the corresponding fee paid to the content publisher) may be determined based on many different factors available to the advertisement selection system. For example, the number of times an ad is selected may be used as a factor when determining the fee. Thus, the advertiser and the advertisement selection system operator can negotiate a graduated cost based on the number of advertisements presented to consumers prior to actual selection of advertisements. This allows the parties to account for the uncertainty that an advertisement may be selected very few times or very many times.

Likewise, the fee may based other information available to the advertisement selection system. For example, a fee may be based on the overall rating of the media file or item of content that the advertisement was selected for. An advertiser may then pay, and the publisher may receive, a higher amount to place ads with more highly rated content. This allows the fee to automatically adjust as the rating of the content adjusts in real time. As another example, the fee may be adjusted based on the demographic of the user receiving the ad, thus allowing the fee to account for an advertiser's desire to reach a particular demographic which will make the system more attractive to those advertisers. As another example, the popularity of the content item may be used to determine the fee, with more popular content increasing the fee.

A pay publisher operation 518 is also performed in which the publisher or owner of the media file is credited or otherwise remunerated for the use of the media file as a vehicle for delivery of the advertisement to the consumer. The pay publisher operation 518 may automatically generate an electronic or paper payment or other credit to the publishers or owners of the media files with which the advertisements are provided. Such payments or credits may also be determined based on a current contract between the publisher and the operators of the advertisement selection system.

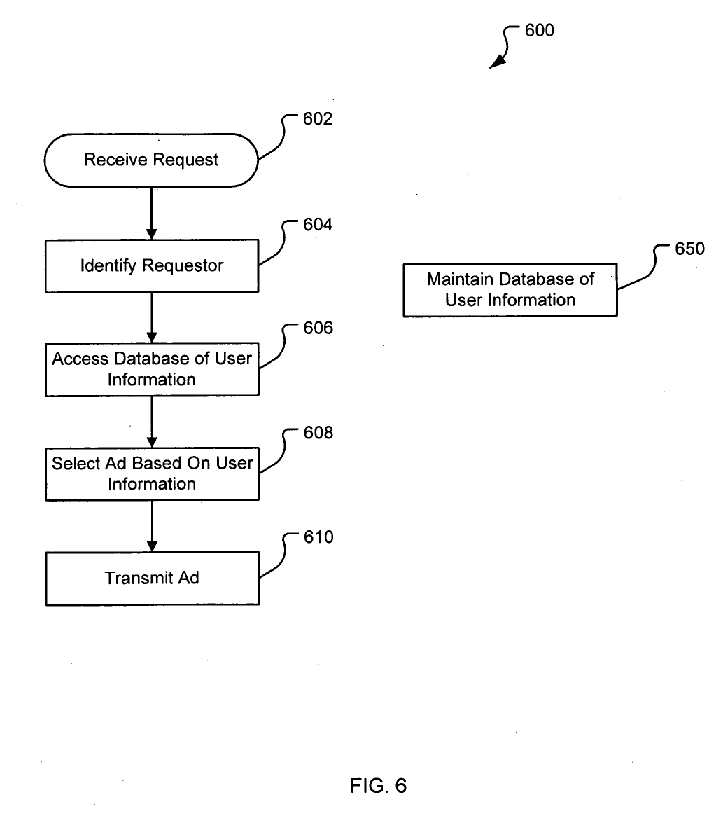

FIG. 6 is a flowchart depicting in greater detail an embodiment of a method for selecting an advertisement and providing it in response to a request for a media file in accordance with the present invention. In the embodiment 600, user data from the user database 170 is accessed in order to select an ad based on information associated with a user related to the request.

ln the embodiment 600, a user information datastore is maintained and accessible to the advertisement selection system. The user information datastore may be a remote database accessible to the advertisement selection system, such as the user information database 170 in FIG. 1, or may be a user database maintained by the advertisement selection system. The user information datastore includes user information associated with each user known to the datastore. As discussed above, user information may include information actively provided by the user, such as demographic information, location, address, and interests, obtained in response to a request for the user to describe himself to the community served by the subscription server 118 and the advertisement selection system 180. The user information may also include a history of the user's transactions and interactions with the subscription server 118 and the advertisement selection system 180. For example, the user information may include a history of all the advertisement transmitted to the user within a certain time period, such as within the last 30 days, which can be referred to as an advertisement consumption history.

In an embodiment, each user known to the user information datastore may be identified by a user identifier and each user identifier is associated with different user information. The user identifier may be a user selected identifier or may be an identifier, not explicitly known to the user, that may be included in a cookie or other data element on the user's computing device from which the user information datastore can identify the user. Thus, in an embodiment, a user may need to log in to the subscription server 118 and thereby allowing the system to explicitly authenticate the user's identity, after which all requests during the session are associated with the user. In an alternative embodiment, authentication is automatic and the user's identity can be determined from inspection of requests from the user.

In the embodiment 600, a request is received in a receive request operation 602, such as described above with reference to FIG. 5. Next, the identity of the requestor is identified in an identify requestor operation 604. The identify requestor operation 604 may include inspecting the request to identify a user identifier. Alternatively, other information may be used to identify the requestor, such as a previously provided user identifier associated with the session that the request is part of or associated with a computing device previously used by the user.

The requestor identified may be a user whose rendering device is the ultimate destination to which the advertisement should be transmitted, which may or may not be may be the same as the source of the request or. For example, the request received in receive operation 602 may be received by the advertisement selection system from an intermediary, such as the subscription server 118 or some other computing device. The intermediary may be simply forwarding requests received to the advertisement selection system or the intermediary may be generating ad selection requests in response to or in anticipation of user requests. The request received by the advertisement selection system may include a direction to the advertisement selection system to transmit the selected ads directly to the source of the initial request, i.e., the user, or may direct the advertisement selection system to return the advertisement to the intermediary for subsequent transmittal to the source of the initial request.

After the requester is identified, the user information datastore is accessed in an access user datastore operation 606 and information associated with the requester is obtained. The user information is then used to select an ad in a selection ad operation 608. The information accessed in the access user datastore operation 606 may be simply inspected or otherwise retrieved from the datastore as necessary depending how the system is implemented.

The select ad operation 608 selects an ad based on the user information associated with the requestor and ad selection criteria, which may be embodied in a set of ad rules as discussed above. For example, if the requestor is associated with user information related to football, the ad selected may be a football-centric version of ad rather than a default ad designed to appeal to all audiences. The selected advertisement is then transmitted as directed by the request in a transmission operation 610, such as discussed with reference to FIG. 5.

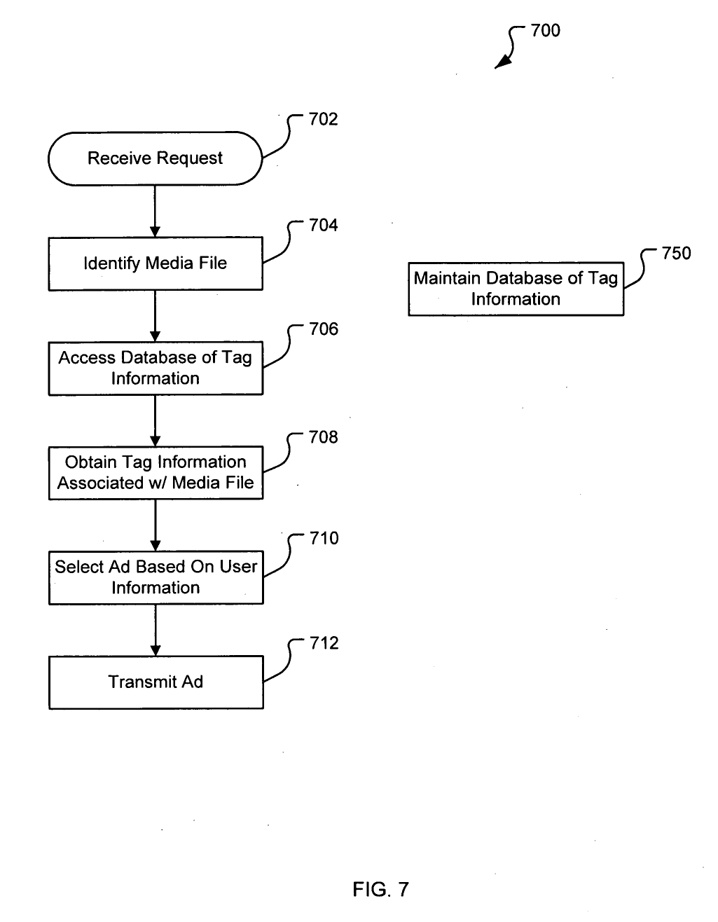

FIG. 7 is a flowchart depicting in greater detail yet another embodiment of a method for selecting an advertisement in accordance with the present invention. In the embodiment 700, tag information, such as that in a feed database described above, is accessed in order to select an ad based on information associated with the requested media file.

In the embodiment 700, a tag information datastore is maintained and accessible to the advertisement selection system. The tag information datastore may be a remote database accessible to the advertisement selection system, such as the feed database 174 in FIG. 1, or may be a tag database maintained by the advertisement selection system. The tag information datastore includes tag information associated with media files, such as a set of one or more tags, identifiers of users that provided the tags, the number of times each tag has been associated with a given media file. As discussed above, a tag is a keyword chosen by a user or a publisher to describe a particular media file or feed. A tag can be any word or combination of key strokes. In an alternative embodiment a tag may also be a media file such as an icon, an image or an audio file.

In an embodiment, each media file known to the tag information datastore may be identified by a media file identifier and each media file identifier is associated with different tag information. In an embodiment, the media file identifier is the URL or some other network location identifier for the media file. In an alternative embodiment, the media file may be identified by some other method, such as via metadata within the media file in which case the media file may need to be obtained or inspected before the media file can be identified by the advertising selection system.

In the embodiment 700, a request is received in a receive request operation 702, such as described above with reference to FIG. 5. The request may be a request for a media file or, alternatively, a request that is somehow associated with a media file such as a request for description information associated with a media file. Next, the identity of the media file is identified in an identify media file operation 704. The identify media file operation 704 may include inspecting the request to identify a media file identifier, such as a URL. Alternatively, the media file may need to be retrieved and inspected in order to identify the media file sufficiently for the purposes of the remaining operations.

After the media file is identified, the tag information datastore is accessed in an access tag datastore operation 706 and information associated with the media file is obtained in an obtain tag information operation 708. The tag information is then used to select an ad in a selection ad operation 710. The information obtained in the obtain tag information operation 708 may be simply inspected or otherwise retrieved from the datastore as necessary depending how the system is implemented.

The select ad operation 710 selects an ad based on the tag information associated with the media file and ad selection criteria, which may be embodied in a set of ad rules as discussed above. For example, if the media file is associated with tag information related to football, the ad selected may be a football-centric version of ad rather than a default ad designed to appeal to all audiences. The selected advertisement is then transmitted as directed by the request in a transmission operation 712, such as discussed with reference to FIG. 5.

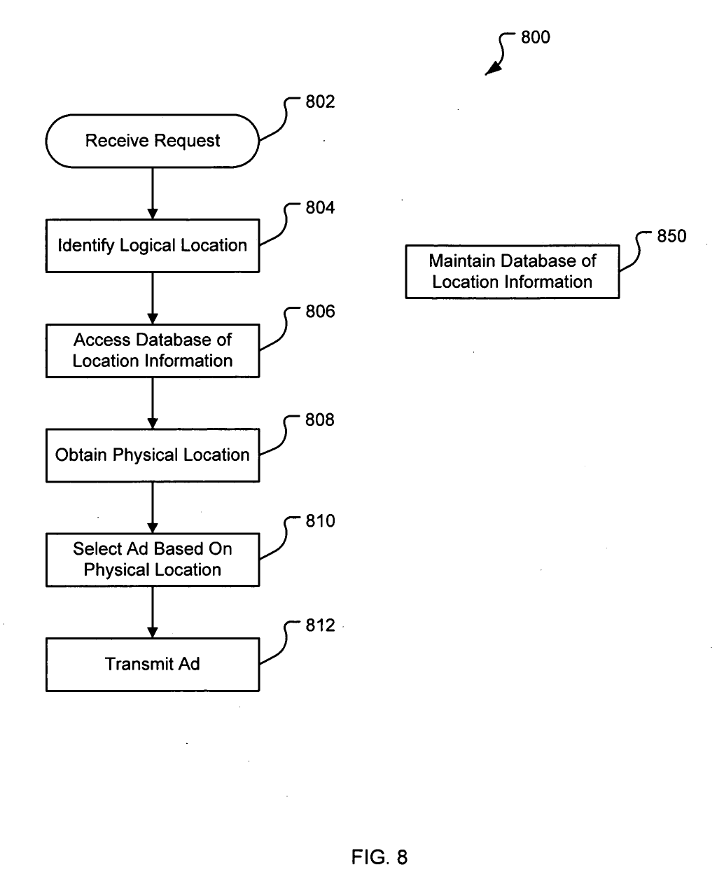

FIG. 8 is a flowchart depicting in greater detail yet another embodiment of a method for selecting an advertisement in accordance with the present invention. In the embodiment 800, a physical location associated with the request is determined in order to automatically select an ad based on the physical location.

The physical location may be associated with a current or presumed location of the destination of the response to the request, with a location associated with a requestor (such as described above with reference to FIG. 6), or with a location associated with a media file (such as described above with reference to FIG. 7 wherein the location may be a tag associated with the media file).

In the embodiment 800, a location information datastore is maintained and accessible to the advertisement selection system in a maintain database operation 850. The location information datastore may be a remote database accessible to the advertisement selection system, such as a domain name system (DNS) database, a whois database or a user information database such as the user database 170 as shown in FIG. 1, or may be a location information database maintained by the advertisement selection system. The location information datastore includes location information associated with either users, computing devices or both, such as a set of one or more locations. If the locations are maintained in a user information database, the locations may be associated with a user identifier.

In an alternative embodiment, a location may be associated with media files in a media file information database such as a feed database 174. This allows media files directed to a specific location to be associated with the location, such as via a location tag associated in the database with the media file.

In the embodiment 800, a request is received in a receive request operation 802, such as described above with reference to FIG. 5. The request may be a request for a media file or, alternatively, a request that is somehow associated with a media file such as a request for description information associated with a media file. Next, a logical location associated with the request is identified in an identify logical location operation 804. The identify logical location operation 804 may include inspecting the request to identify a logical identifier that can be used to resolve to a physical location in a later operation. In embodiments, logical identifiers may be one or more a user identifier, a media file identifier, or a computing device identifier. For example, identify logical location operation 804 may identify an IP address of the destination computing device to which the response to the request should be sent.

After the media file is identified, the location information datastore is accessed in an access location datastore operation 806 and information associated with the logical address is obtained in an obtain physical location operation 808. The location information is then used to select an ad in a selection ad operation 810. The information obtained in the obtain physical location operation 808 may be simply inspected or otherwise retrieved from the datastore as necessary depending how the system is implemented.

The select ad operation 810 selects an ad based on the physical location associated with the request and ad selection criteria, which may be embodied in a set of ad rules as discussed above. For example, if the request is for delivery of a media file to San Francisco, the ad selected may be an ad directed to San Francisco residents. The selected advertisement is then transmitted as directed by the request in a transmission operation 812, such as discussed with reference to FIG. 5.

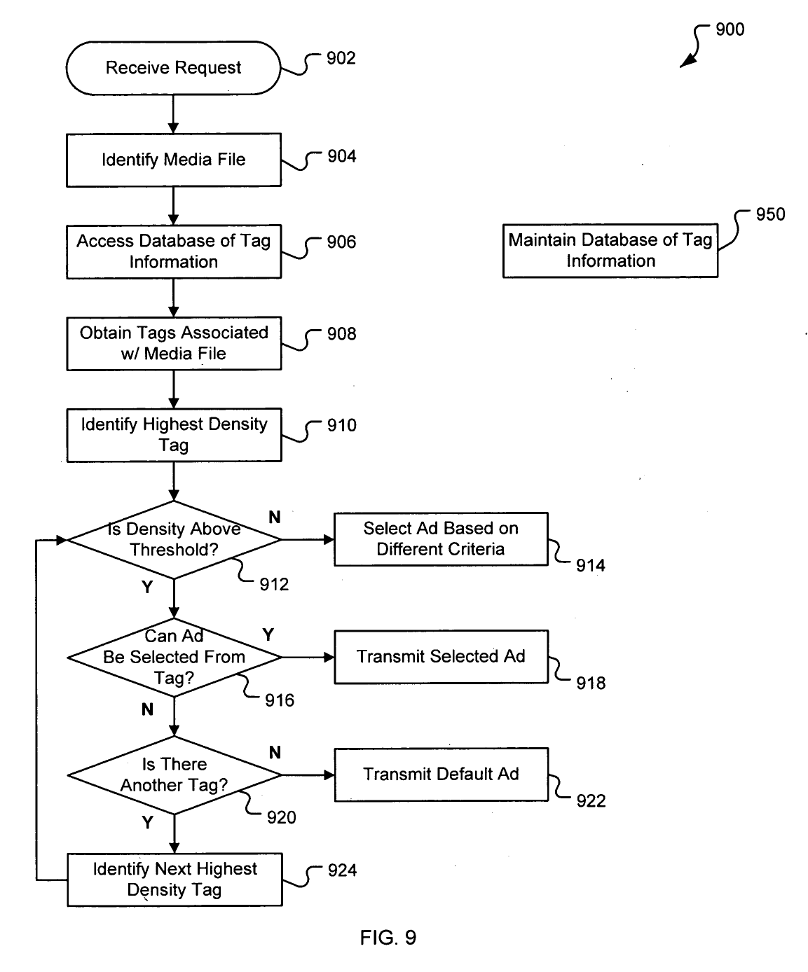

FIG. 9 is a flowchart depicting in greater detail yet another embodiment of a method for selecting an advertisement in accordance with the present invention. In the embodiment 900, tag information associated with the requested media file is accessed in order to select an ad based on information associated with the requested media file.

In the embodiment 900, a tag information datastore is maintained and accessible to the advertisement selection system. The tag information datastore may be a remote database accessible to the advertisement selection system, such as the feed database 174 in FIG. 1, or may be a tag database maintained by the advertisement selection system. The tag information datastore includes tag information associated with media files, such as a set of one or more tags, identifiers of users that provided the tags, and the number of times each tag has been associated with a given media file, which is also referred to as the tag density. As discussed above, a tag includes a descriptor in the form of a keyword chosen by a user or a publisher to describe a particular media file or feed. A tag can be any word, phrase-or combination of key strokes. In an alternative embodiment a tag may also be a media file such as an icon, an image or an audio file.

Generally, a tag density is a metric for determining how accurate a tag given tag is at describing a given media file. Since tags are provided by members of the population consuming the media files, tags that are more often provided by the members are considered to be a more accurate description of the media file to the population as a whole. In an embodiment, each member can provide a given tag only once for any given file. Thus, one user can not skew the metric by providing the same tag multiple times for the same media file. In an embodiment, a tag may be considered to include the descriptor of the tag and the tag density associated with the descriptor. In an alternative embodiment, the tag may be thought of as the descriptor and the tag density may be considered a separate element. For the purposes of the specification, unless otherwise designated, a tag includes a descriptor and a tag density..

In an embodiment, each media file known to the tag information datastore may be identified by a media file identifier and each media file identifier is associated with different tag information. In an embodiment, the media file identifier is the URL or some other network location identifier for the media file. In an alternative embodiment, the media file may be identified by some other method, such as via metadata within the media file in which case the media file may need to be obtained or inspected before the media file can be identified by the advertising selection system.

In the embodiment 900, a request is received in a receive request operation 902, such as described above with reference to FIG. 5. The request may be a request for a media file or, alternatively, a request that is somehow associated with a media file such as a request for description information associated with a media file. Next, the identity of the media file is identified in an identify media file operation 904. The identify media file operation 904 may include inspecting the request to identify a media file identifier, such as a URL. Alternatively, the media file may need to be retrieved and inspected in order to identify the media file sufficiently for the purposes of the remaining operations.

After the media file is identified, the tag information datastore is accessed in an access tag datastore operation 906 and one or more tags associated with the media file are obtained in an obtain tag information operation 908. In the embodiment 900, the tag information obtained includes at least one tag associated with the media file. As discussed above with reference to FIG. 1, each tag includes a descriptor or description portion(i.e., the description portion of the tag such as “fantasy football”) associated with the media file and, for each tag, that tag's associated tag density. The information obtained in the obtain tag information operation 708 may be simply inspected or otherwise retrieved from the datastore as necessary depending how the system is implemented.

After the tag information is obtained, the tag with the highest tag density is identified in an identify highest density tag operation 910. The highest density tag is the tag considered most descriptive of the media file based on information received from consumers of the media file. In an embodiment, the tag density is the number of users that have identified the media file with the tag at the time when the tag information was received. The highest density tag, then, is the tag having the highest number. In an alternative embodiment, the tag density may be a metric scored in a different way other than an absolute number using a number scale. For example, separate tag densities may be maintained based sub-populations and the highest density tag may be determined based on some weighted average of the relevance of the sub-population to the advertisement. The highest density tag operation 910 then passes the tag with the highest tag density for further evaluation by the advertisement selection system.

Next, a tag density threshold determination operation 912 determines if the tag density of the tag being evaluated is greater than some minimum threshold. This prevents media files with relatively little or no tag information from the consumer population from being used as a basis to select an ad. The threshold may be selected so that only a tag descriptor selected by a sufficient number of consumers are used as a basis for an ad selection. The threshold may be different for different types of media files or for different categories of tags.

If the threshold determination operation 912 determines that the tag's tag density is less than the predetermined threshold, then the method 900 ends with an ad being selected based on some other criteria than tag information in a select ad operation 914. In an embodiment, this may be a select default ad operation or may be another selection method such as those described above reference to FIGS. 5-8. For example, if there are no consumer generated tags above the threshold, the select ad operation 914 may select an ad based on publisher generated tags instead.

If the threshold determination operation 912 determines that the tag's tag density meets or exceeds the predetermined threshold, a selection determination operation 916 determines if, based on the ad rules and descriptor an ad can be selected from the tag. As discussed above, this may include traversing a hierarchy of selection rules having selection criteria to determine if an ad is ultimately given the tag's descriptor being evaluated. If an ad can be selected from the set of possible advertisements based on the highest density tag, then the selected advertisement is transmitted as directed by the request in a transmission operation 918, such as discussed with reference to FIG. 5.

In the embodiment shown, if the advertisement selection system determines that an ad can not be selected from the tag being evaluated, then an identify next tag determination operation 920 determines if there is another tag in the datastore associated with the media file that has not been evaluated. If all tags have been evaluated, then in the embodiment shown a default ad is selected and the selected advertisement is transmitted as directed by the request in a transmit default ad operation 922, such as discussed with reference to FIG. 5.

If the identify next tag determination operation 920 determines that there are one or more tags associated with the media file that have not yet been evaluated, then an identify next highest density tag operation 924 is performed. The identify next highest density tag operation 924 identifies the next most descriptive tag associated with the media file based on the tag density metric. After identifying the next most descriptive tag, then flow returns to the threshold determination operation 912, discussed above.

In the embodiment 900, each tag associated with a media file that has a sufficiently high tag density may be evaluated in order to select the most appropriate ad. In addition, as the database is continually receiving new information from members of the consuming population, a request from the same user for the same media file received at a later time, may not result in the selection of the same ad, as the tag density may have changed in the interim. This may also occur if the ad selection rules include rules, such as those described above using user information, to prevent sending the same ad multiple times or within a certain period of time to the same user.

The embodiment 900 allows tags to be used in a similar fashion as keywords, allowing advertisers to “buy” tag descriptors with sufficiently high densities to automatically ensure that a media file is accurately described by the tag. The price for placing an ad may further be affected by the tag density of a tag so that media files with tags having higher tag densities may be more expensive to place an ad in than media files with tags having lower tag densities.

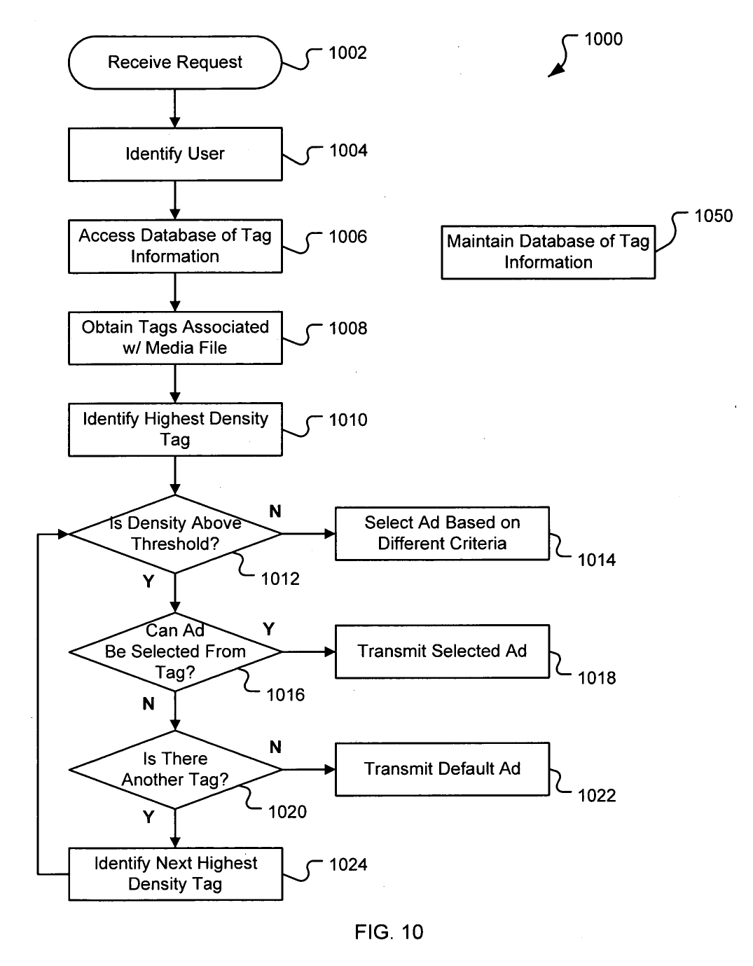

FIG. 10 is a flowchart depicting in greater detail yet another embodiment of a method for selecting an advertisement in accordance with the present invention. In the embodiment 1000, tag information associated with the requestor of the media is accessed in order to select an ad based on information associated with the requestor.

In the embodiment 1000, a tag information datastore is maintained and accessible to the advertisement selection system. The tag information datastore may be a remote database accessible to the advertisement selection system, such as the user information database 170 in FIG. 1, or may be a user associated tag database maintained by the advertisement selection system. In the embodiment 1000, the tag information datastore includes tag information associated with users, such as a set of one or more tags provided by users to describe various media files, identifiers of the media files the users provided the tags for, and the number of times each tag has been associated by each particular user with a media file, which is another form of tag density. In this context, the tag density provides a metric for what interests the associated user may have. For example, a user interested in football will presumably seek out media files related to football and therefore tag more media files with the descriptor “football” than a user that has no interest in football. In this way, the tag density of tags provided by users may be used to as a metric for the user's interest.

In an embodiment, each user known to the tag information datastore may be identified by a user identifier and each user identifier is associated with different tag information. In an embodiment, the user identifier is a user account name or some other network user identifier for the user. In an alternative embodiment, the user may be identified by some other method, such as via metadata provided with the request in which case the metadata may need to be interpreted before the user file can be identified by the advertising selection system.

In the embodiment 1000, a request is received in a receive request operation 1002, such as described above with reference to FIG. 5. The request may be a request for a media file or, alternatively, a request that is somehow associated with a media file such as a request for description information associated with a media file. Next, the identity of the user associated with the request, for example the user making the request, is identified in an identify user operation 1004. The identify user operation 1004 may include inspecting the request to identify a user identifier, such as a account name.

After the user is identified, the tag information datastore is accessed in an access tag datastore operation 1006 and one or more tags associated with the user are obtained in an obtain tag information operation 1008. In the embodiment 1000, the tag information obtained includes at least one tag associated with the user. As discussed above with reference to FIG. 1, each tag includes a descriptor or description portion (i.e., the description portion of the tag such as “fantasy football”) that was provided by the user as a description of a media file and, for each tag, that tag's associated tag density, which is now the number of media files a user has associated the tag descriptor with. The information obtained in the obtain tag information operation 708 may be simply inspected or otherwise retrieved from the datastore as necessary depending how the system is implemented.

After the tag information is obtained, the tag with the highest tag density is identified in an identify highest density tag operation 1010. The highest density tag is the tag considered most descriptive of the user based on information provided by the user as part of his consumption of media files. The highest density tag may be the tag having the highest number. In an alternative embodiment, the tag density may be a metric scored in a different way other than an absolute number using a number scale. For example, separate tag densities may be maintained based a user's consumption or subscription habits and the highest density tag may be determined based on some weighted average of the tags for media files actually consumed by the user. The highest density tag operation 1010 then passes the tag with the highest tag density for further evaluation by the advertisement selection system.

Next, a tag density threshold determination operation 1012 determines if the tag density of the tag being evaluated is greater than some minimum threshold. This prevents users that have provided relatively little or no tag information from having their tag information used as a basis to select an ad. The threshold may be selected so that only a tag descriptor selected by a number of times are used as a basis for an ad selection. The threshold may be different for different types of media files or for different categories of tags.

If the threshold determination operation 1012 determines that the tag's tag density is less than the predetermined threshold, then the method 1000 ends with an ad being selected based on some other criteria than tag information in a select ad operation 1014. In an embodiment, this may be a select default ad operation or may be another selection method such as those described above reference to FIGS. 5-8. For example, if there are no user generated tags above the threshold, the select ad operation 1014 may select an ad based on the tags associated with the requested media file instead.

The threshold determination operation 1012 may also automatically screen out tags associated with negative connotations. For example, early use of tags as descriptors indicates that “zzzzz” and similar tags are often used by consumers to indicate a media file is boring. This is an example of a tag with a negative connotation and such a tag would not be used to select an advertisement, as it is presumed that users are not interested in boring media files. Positive connotation tags, such as “interesting” and “rad” may also be screened out by the threshold determination operation 1012 as they are too general to be used for a selection.

If the threshold determination operation 1012 determines that the tag's tag density meets or exceeds the predetermined threshold, a selection determination operation 1016 determines if, based on the ad rules and descriptor an ad can be selected from the tag. As discussed above, this may include traversing a hierarchy of selection rules having selection criteria to determine if an ad is ultimately given the tag's descriptor being evaluated. If an ad can be selected from the set of possible advertisements based on the highest density tag, then the selected advertisement is transmitted as directed by the request in a transmission operation 1018, such as discussed with reference to FIG. 5.

In the embodiment shown, if the advertisement selection system determines that an ad can not be selected from the tag being evaluated, then an identify next tag determination operation 1020 determines if there is another tag in the datastore associated with the user that has not been evaluated. If all tags have been evaluated, then in the embodiment shown a default ad is selected and the selected advertisement is transmitted as directed by the request in a transmit default ad operation 1022, such as discussed with reference to FIG. 5.

If the identify next tag determination operation 1020 determines that there are one or more tags associated with the user that have not yet been evaluated, then an identify next highest density tag operation 1024 is performed. The identify next highest density tag operation 1024 identifies the user's next most provided descriptor with the media file based on the tag density metric. After identifying the next most provided tag, then flow returns to the threshold determination operation 1012, discussed above.

In the embodiment 1000, each tag provided by a user that has a sufficiently high tag density may be evaluated in order to select the most appropriate ad. In addition, as the database is continually receiving new information from members of the consuming population, a request from the same user for the same media file received at a later time, may not result in the selection of the same ad, as the tag density of tags provided by the user may have changed in the interim. This may also occur if the ad selection rules include rules, such as those described above using user information, to prevent sending the same ad multiple times or within a certain period of time to the same user.

Those skilled in the art will recognize that the methods and systems of the present invention within this specification may be implemented in many manners and as such is not to be limited by the foregoing exemplary embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible. For example, the above discussed methods could be used to provide multiple advertisements with a single media file. The system may be implemented so that each rendering of a media file, even a media file already stored locally on a rendering device, results in the selection and rendering of a new ad for which the publisher is rewarded and the advertiser is billed. As another example, the system could be used to select ads for any situation, such as in response to a request for a web page on a specific subject, or in response to a user's use of a specific software component. Thus, the embodiments of the present invention are not limited to use with media files, but can be used to automatically select ads in response to any digital transaction.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present invention covers conventionally known and features of those variations and modifications through the system component described herein as would be understood by those skilled in the art.

What is claimed is:

1. A method for targeting an advertisement to a member of a population comprising:
maintaining a database of tags previously provided by members of the population;
receiving a request for a media file from the member of the population;
accessing the database for tags associated with the media file;
obtaining from the database a set of one or more first tags associated with the media file, each first tag including a description of the media file previously provided by at least one member of the population to describe the media file and each first tag having a tag density associated with the description;
selecting an advertisement from a plurality of advertisements based on the descriptions and tag densities in the set of first tags; and
transmitting the selected advertisement to the member of the population.

2. The method of claim 1 wherein selecting further comprises:
identifying a highest density tag in the set of first tags, the highest density tag being the first tag in the set of first tags with the highest tag density; and
selecting the advertisement based on the highest density tag.

3. The method of claim 2 further comprising:
if there is no advertisement associated with the highest density tag,
identifying a next highest density tag in the set of first tags, the next highest density tag being a first tag in the set of first tags with the next highest tag density;
selecting an advertisement based on the next highest density tag.

4. The method of claim 1 further comprising:
revising the database of tags as members of the population provide tags associated with the media file, thereby changing the advertisement selected by the selecting operation.

5. The method of claim 1 wherein the tag density of a first tag is a number corresponding to the number of members of the population that associated the description of the first tag with the media file.

6. The method of claim 2 further comprising:
if the tag density of the highest density tag is lower than a predetermined minimum density,
selecting a default advertisement.

7. The method of claim 2 further comprising:
if the tag density of the highest density tag is lower than a predetermined minimum density,
obtaining a set of one or more second tags, each of the second tags previously provided by a publisher of the media file; and
selecting the advertisement based on the second tags.

8. A method for targeting an advertisement to a first member of a population comprising:
maintaining a database of tags provided by members of the population, including tags provided by the first member;
receiving a request for a media file from a first member of the population;
obtaining from the database a set of one or more first tags associated with the first member, each first tag including a description previously provided by the first member of the population to describe one or more media files and each first tag including a tag density associated with the description, wherein the tag density of a first tag is a number corresponding to the number of media files the first member has previously associated with the description of the first tag;
selecting an advertisement from a plurality of advertisements based on the descriptions and tag densities in the set of one or more first tags; and
transmitting the selected advertisement to the first member of the population.

9. The method of claim 8 wherein selecting further comprises:
identifying a highest density tag in the set of first tags, the highest density tag being the first tag in the set of first tags with the highest tag density;
selecting an advertisement based on the highest density tag.

10. The method of claim 9 further comprising:
if there is no advertisement associated with the highest density tag,
identifying a next highest density tag in the set of first tags, the next highest density tag being the first tag in the set of first tags with the next highest tag density;
selecting an advertisement based on the next highest density tag.

11. The method of claim 8 further comprising:
revising the database of tags as the first member provides tags associated with media files.

12. The method of claim 9 further comprising:
if the tag density of the highest density tag is lower than a predetermined minimum density,
selecting a default advertisement.

13. The method of claim 9 further comprising:
if the tag density of the highest density tag is lower than a predetermined minimum density,
obtaining a set of demographic information associated with the first member; and
selecting the advertisement based on the demographic information associated with the first member.

14. A system comprising:
a request interception module adapted to receive a request for a media file and to inspect the request to determine if an advertisement is associated with the media file;
an advertisement retrieval module adapted to select an advertisement and retrieve the selected advertisement from an advertisement library based on information contained in the request;
a transmission module adapted to create a response to the request and to transmit the response, the response including the selected advertisement and when rendered resulting in the rendering of the advertisement.

15. The system of claim 14 further comprising:
an advertisement library containing a plurality of advertisements, the plurality of advertisements including the selected advertisement.

16. The system of claim 14 further comprising:
a set of advertisement selection rules including at least one rule dictating the selection of the selected advertisement from a plurality of advertisements based on information contained in the request.

17. The system of claim 14 wherein the request interception module is adapted to receive a request from a rendering device and the transmission module is adapted to transmit the response to the rendering device.

18. The system of claim 17 further comprising:
a media file library containing the media file.

19. The system of claim 18 wherein the media file library is accessible at a first network location remote from the request interception module.

20. The system of claim 15 wherein the advertisement library is accessible at a second network location remote from the advertisement insertion module.

21. The system of claim 14 further comprising:
a billing module that automatically generates a bill for an advertiser associated with the selected advertisement.

22. The system of claim 17 further comprising:
a location module adapted to determine a physical location associated with the rendering device based on information in the request; and
wherein the advertisement retrieval module is adapted to select an advertisement based on the physical location associated with the rendering device.

23. The system of claim 14 further comprising:
a tag information datastore, the tag information datastore including a plurality of user identifiers, each user identifier associated with a different user, and, associated with each user identifier, information provided by the associated user;
wherein the request is associated with one of the plurality of user identifiers; and
wherein the advertisement retrieval module is adapted to select an advertisement based on the tag information associated the one of the plurality of user identifiers.

24. The system of claim 23 further comprising:
wherein the tag information datastore includes advertisement consumption history information associated with the one of the plurality of user identifiers, the advertisement consumption history information identifying advertisements previously transmitted in responses requests associated with the one of the plurality of user identifiers; and
wherein the advertisement retrieval module is adapted to select an advertisement based on the advertisement consumption history information associated the one of the plurality of user identifiers.

25. The system of claim 14 further comprising:
a tag information datastore, the tag information datastore including, for each of a plurality of media files, an associated set of one or more tags, the tags previously provided by users associated with a user identifier; and
wherein the advertisement retrieval module is adapted to access the tag information associated with the media file and to select an advertisement based on the set of one or more tags associated with the media file.

26. A computer-readable medium having computer-executable instructions for performing a method, the method comprising:
receiving, from a requesting device, a request for a media file;
selecting an advertisement from a plurality of advertisements based on the request; and
transmitting the advertisement to the requesting device.

27. The computer-readable medium of claim 26 wherein the method further comprises:
accessing a tag information datastore containing requestor information associated with a source of the request; and
selecting an advertisement based on the requestor information.

28. The computer-readable medium of claim 27 wherein the method further comprises:
determining a requestor identifier identifying the source of the request for the media file; and
accessing requestor information associated with the requestor identifier in the tag information datastore.

29. The computer-readable medium of claim 26 wherein the method further comprises:
maintaining the tag information datastore, the tag information datastore including a plurality of user identifiers, each user identifier associated with a different user, and, associated with each user identifier, information provided by the associated user wherein the requestor identifier is one of the plurality of user identifiers and the requestor information is information previously provided by the user associated with requestor identifier.

30. The computer-readable medium of claim 26 wherein the method further comprises:
identifying tag information associated with the media file; and
selecting advertisement based on the tag information associated with the media file.

31. The computer-readable medium of claim 30 wherein the method further comprises:
maintaining a tag information datastore, the tag information datastore including for each of a plurality of media files, an associated set of one or more tags, the tags previously provided by users associated with a user identifier; and
accessing tag information associated with the media file in a user media file datastore.

32. The computer-readable medium of claim 26 wherein the method further comprises:
identifying a physical location associated with the requesting device based on the request for the media file; and
selecting an advertisement based on the physical location associated with the requesting device.

33. The computer-readable medium of claim 32 wherein the method further comprises:
determining an IP address associated with the requesting device;
estimating the physical location based on a location assigned to the IP address in a domain name system database.

34. The computer-readable medium of claim 29 wherein the method further comprises:
wherein the tag information datastore includes advertisement consumption history information associated with the requestor identifier, advertisement consumption history information the identifying advertisements previously transmitted to the user associated with the requestor identifier; and
selecting an advertisement based on the advertisement consumption history information associated with the requestor identifier.

35. The computer-readable medium of claim 34 wherein the advertisement consumption history information associated with the requester indicates that the requester has received a first advertisement of a sequence of related advertisements and selecting comprises:
selecting a second advertisement, the second advertisement being a next advertisement in the sequence of related advertisements.

36. The computer-readable medium of claim 26 wherein the method further comprises:
maintaining a set of advertisement selection rules including at least one advertisement selection rule associated each advertisement in the plurality of advertisements; and
applying the advertisement selection rules to the request to identify at least one advertisement from the plurality of advertisements.

37. The computer-readable medium of claim 34 wherein the selected advertisement is transmitted with the media file to the requesting device.

38. The computer-readable medium of claim 26 wherein the method further comprises:
recording that the advertisement was transmitted to the requesting device;
billing an advertiser associated with the advertisement a first fee; and
crediting an account associated with the media file a second fee.

39. A method comprising:
receiving, from a requesting device, a request for a media file;
selecting an advertisement from a plurality of advertisements based on the request; and
transmitting the advertisement to a destination computing device.

40. The method of claim 39 further comprising:
accessing a tag information datastore containing requestor information associated with a source of the request; and
selecting an advertisement based on the requestor information.

41. The method of claim 40 wherein accessing further comprises:
determining a requestor identifier identifying the source of the request for the media file; and
accessing requestor information associated with the requestor identifier in the tag information datastore.

42. The method of claim 39 further comprising:
maintaining the tag information datastore, the tag information datastore including a plurality of user identifiers, each user identifier associated with a different user, and, associated with each user identifier, information provided by the associated user wherein the requester identifier is one of the plurality of user identifiers and the requester information is information previously provided by the user associated with requester identifier.

43. The method of claim 39 further comprising:
identifying tag information associated with the media file; and
selecting advertisement based on the tag information associated with the media file.

44. The method of claim 43 further comprising:
maintaining a tag information datastore, the tag information datastore including for each of a plurality of media files, an associated set of one or more tags, the tags previously provided by users associated with a user identifier; and
accessing tag information associated with the media file in a user media file datastore.

45. The method of claim 39 further comprising:
identifying a physical location associated with the requesting device based on the request for the media file; and
selecting an advertisement based on the physical location associated with the requesting device.

46. The method of claim 45 wherein identifying further comprises:
determining an IP address associated with the requesting device;
estimating the physical location based on a location assigned to the IP address in a domain name system database.

47. The method of claim 42 further comprising:
wherein the tag information datastore includes advertisement consumption history information associated with the requestor identifier, advertisement consumption history information the identifying advertisements previously transmitted to the user associated with the requestor identifier; and
selecting an advertisement based on the advertisement consumption history information associated with the requestor identifier.

48. The method of claim 47 wherein the advertisement consumption history information associated with the requestor indicates that the requester has received a first advertisement of a sequence of related advertisements and selecting comprises:
selecting a second advertisement, the second advertisement being a next advertisement in the sequence of related advertisements.

49. The method of claim 39 further comprising:
maintaining a set of advertisement selection rules including at least one advertisement selection rule associated each advertisement in the plurality of advertisements; and
applying the advertisement selection rules to the request to identify at least one advertisement from the plurality of advertisements.

50. The method of claim 47 wherein the selected advertisement is transmitted with the media file to the requesting device.

51. The method of claim 39 further comprising:
recording that the advertisement was transmitted to the requesting device;
billing an advertiser associated with the advertisement a first fee; and
crediting an account associated with the media file a second fee.
